(19) United States
(12) Patent Application Publication
(10) Pub. No.: US 2015/0254767 A1
(43) Pub. Date: Sep. 10, 2015

(54) LOAN SERVICE REQUEST DOCUMENTATION SYSTEM

(71) Applicant: Bank of America Corporation, Charlotte, NC (US)

(72) Inventor: Rodrigo Villalta Vargas, San Jose (CR)

(73) Assignee: Bank of America Corporation, Charlotte, NC (US)

(21) Appl. No.: 14/203,074

(22) Filed: Mar. 10, 2014

(51) Int. Cl. G06Q 40/02; G06F 3/0482; G06F 3/0484

(52) U.S. Cl. CPC G06Q 40/025; G06F 3/0482; G06F 3/04842

(57) ABSTRACT

The present invention includes an apparatus for documenting a loan service request. The apparatus comprises: a memory; a processor; and a module stored in memory, executable by a processor, and configured to: prompt a user for information associated with the loan service request via a first interface; receive information associated with the loan service request; process the information associated with the loan service request, wherein processing the information associated with the loan service request includes generating text that corresponds to the information associated with the loan service request; and display the text that corresponds to the information associated with the loan service request to the user via a second interface.

### BACKGROUND

There is a need to efficiently process and document incoming loan service requests.

### BRIEF SUMMARY OF THE INVENTION

The present invention is directed to a software-based tool that enables a user (e.g., a customer service representative, an account manager, or the like) to efficiently document a loan service request. The user receives a loan service request via telephone, a web-based chat, an email, or via another method. During a loan service request call, the user may utilize the present invention to ensure that the loan service request is properly documented. The present invention may prompt the user with instructions to collect and input various pieces of information associated with the loan service request. Upon completing the entry of information associated with the loan service request, the present invention may generate a string of text that corresponds to and effectively communicates the inputted information associated with the loan service request. The string of text may be generated according to a predetermined template so that the documentation of loan service requests is uniform and easily transferrable among various financial applications, entities, and agents associated with providing loan services.

In some embodiments, an apparatus for documenting a loan service request is provided. The apparatus comprises: a memory; a processor; and a module stored in memory, executable by a processor, and configured to: prompt a user for information associated with the loan service request via a first interface; receive information associated with the loan service request; process the information associated with the loan service request, wherein processing the information associated with the loan service request includes generating text that corresponds to the information associated with the loan service request; and display the text that corresponds to the information associated with the loan service request to the user via a second interface.

In some embodiments, the first interface includes at least one of a check box, a text input field, a selection menu, and a button.

In some embodiments, the first interface enables the user to manually input information associated with the loan service request.

In some embodiments, receiving information associated with the loan service request includes retrieving information associated with the loan service request from a second apparatus.

In some embodiments, receiving information associated with the loan service request further includes prefilling the first interface with information associated with the loan service request.

In some embodiments, the information associated with the loan service request includes at least one of contact information, account information, or identity verification information associated with a customer.

In some embodiments, contact information includes at least one of a customer name, a phone number, a physical address, an email address, a social security number, and a customer number.

In some embodiments, account information includes at least one of an account number, a customer number, a loan number, a service request number, a service request history, a purchase history, an account balance, an invoice amount, a credit balance, an account type, an account status, and a routing number.

In some embodiments, identity verification information includes at least one of a username, a password, a personal identification number (PIN), a security question, an answer to a security question, a number of identity verification attempts, a status, location information, and a biometric.

In some embodiments, processing the information associated with the loan service request does not include storing the information associated with the loan service request.

In some embodiments, processing the information associated with the loan service request includes deleting the information associated with the loan service request.

In some embodiments, processing the information associated with the loan service request includes translating at least one of a checked box, an inputted text string, an inputted numerical string, and a selection into a text string.

In some embodiments, generating text that corresponds to the information associated with the loan service request includes generating the text according to a predetermined template.

In some embodiments, displaying the text that corresponds to the information associated with the loan service request includes copying the text to a virtual clipboard.

In some embodiments, displaying the text that corresponds to the information associated with the loan service request includes transmitting the text to a second apparatus for documentation purposes.

In some embodiments, processing the information associated with the loan service request includes receiving an electronic payment.

In some embodiments, processing the information associated with the loan service request includes authenticating a customer associated with the loan service request.

In some embodiments, prompting the user for information associated with the loan service request includes providing instructions to the user for at least one of inputting, receiving, and processing information associated with the loan service request.

In some embodiments, a method for documenting a loan service request is provided. The method comprises: prompting a user for information associated with the loan service request via a first interface; receiving information associated with the loan service request; processing the information associated with the loan service request, wherein processing the information associated with the loan service request includes generating text that corresponds to the information associated with the loan service request; and displaying the text that corresponds to the information associated with the loan service request to the user via a second interface.

In some embodiments, a computer program product for documenting a loan service request is provided. The computer program product comprises: a memory; a processor; and a module stored in memory, executable by a processor, and configured to: prompt a user for information associated with the loan service request via a first interface; receive information associated with the loan service request; process the information associated with the loan service request, wherein processing the information associated with the loan service request includes generating text that corresponds to the information associated with the loan service request; and display the text that corresponds to the information associated with the loan service request to the user via a second interface.

The present invention provides many benefits to the documentation process of a loan service request. The present invention eliminates a substantial amount of time spent documenting a loan service request and its associated information because the present invention provides a streamlined tool that prompts the user for information deemed necessary for documentation. Furthermore, the present invention provides the user with an organized and formal script of generated text that is easily copied, making the transfer of the loan service request and its associated information much more efficient. Additionally, formalizing the information associated with the loan service request enables the user and other users either internal or external to a loan service provider to easily locate critical pieces of information in the generated string of text. Therefore, the present invention dramatically improves communication of the loan service request and its associated information while minimizing the potential for documentation mistakes.

### BRIEF DESCRIPTION OF THE DRAWINGS

Having thus described embodiments of the invention in general terms, reference will now be made to the accompanying drawings, where:

FIG. 1 is a block diagram illustrating technical components of a system for documenting a loan service request, in accordance with embodiments of the present invention;

FIG. 2 is a process flow diagram for documenting a loan service request, in accordance with embodiments of the present invention;

FIG. 3 is an exemplary landing page, in accordance with embodiments of the present invention;

FIG. 4 is an exemplary menu page, in accordance with embodiments of the present invention;

FIG. 5A is an exemplary verification page for Type 1.1 Collections, in accordance with embodiments of the present invention;

FIG. 5B is an exemplary verification page for Type 1.2 Collections, in accordance with embodiments of the present invention;

FIG. 5C is an exemplary verification page for Type 1.3 Collections, in accordance with embodiments of the present invention;

FIG. 5D is an exemplary verification page for Type 2 Collections, in accordance with embodiments of the present invention;

FIG. 5E is exemplary verification page for T Type 3 Collections, in accordance with embodiments of the present invention;

FIG. 6A is an exemplary Questions/Payment Intentions page for Type 1 Collections, in accordance with embodiments of the present invention;

FIG. 6B is an exemplary Resolution Activities page for Type 2 Collections, in accordance with embodiments of the present invention;

FIG. 6C is an exemplary Questions/Payment Intentions page for Type 3 Collections, in accordance with embodiments of the present invention;

FIG. 7A is an exemplary Income/Expenses & Debts/Treatment Options page for Type 1 Collections, in accordance with embodiments of the present invention;

FIG. 7B is an exemplary Resolution Activities page for Type 2 Collections, in accordance with embodiments of the present invention;

FIG. 7C is an exemplary Income/Expenses & Debts/Treatment Options page for Type 3 Collections, in accordance with embodiments of the present invention;

FIG. 8 is an exemplary Litigation page for Type 3 Collections, in accordance with embodiments of the present invention;

FIG. 9A is an exemplary Wrap Up page for Type 1 Collections, in accordance with embodiments of the present invention;

FIG. 9B is an exemplary Wrap Up page for Type 2 Collections, in accordance with embodiments of the present invention;

FIG. 9C is an exemplary Wrap Up page for Type 3 Collections, in accordance with embodiments of the present invention; and

FIG. 10 is an exemplary text output display for Type 1, 2, and 3 Collections, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

In some embodiments, a “user” may be a customer service representative, an internal operations specialist, an account manager, a loan specialist, or another agent associated with the entity.

The present invention provides a system for standardizing a documentation process when receiving a loan service request. By standardizing the documentation process, the potential for documentation errors in processing the loan service request may be reduced. Furthermore, standardizing the loan service request documentation process may decrease handle time and wrap-up time (e.g., time spent documenting and/or processing the loan service request). Therefore, standardization of the loan service request documentation process may increase efficiency in the overall processing of loan service requests, and may extend into other financial products in the future. In some embodiments, the present invention is directed toward documenting and processing a service request associated with a loan. In other embodiments, the present invention is directed toward documenting and processing a service request associated with another financial product or service.

Loan service requests may be classified by a type of collection or a subtype of collection. In some embodiments, Type 1 Collections refer to Home for Investment (HFI) or Service-for-Others (SFO) Collections. In other embodiments, Type 1.1 Collections refer to Regular Collections. In still other embodiments, Type 1.2 Collections refer to WC-8 Collections. In still other embodiments, Type 1.3 Collections refer to WC-5 Collections. In still other embodiments, Type 2 Collections refer to an Account Specialist. In still other embodiments, Type 3 Collections refer to CAST Collections.

In specific embodiments, the user receives a loan service request via a variety of methods. In some embodiments, the user may receive a loan service request via telephone (e.g., when a caller calls a customer service phone number associated with the entity). In other embodiments, the user receives a loan service request via an electronic transmission (e.g., an email, a chat, or the like). In alternative embodiments, the user receives a loan service request in person or on paper. The user may receive the loan service request directly from a caller (e.g., a customer), an agent associated with the entity, an agent associated with a third party customer service provider, or from another source.

Embodiments of the present invention are used to lead the user through the processing and documenting of the received loan service request. In some embodiments, the present invention may prompt the user with directions or instructions via an interface of how to appropriately process or document the loan service request, a list of questions to ask the caller in regards to the loan service request, or the like. In other embodiments, as the user processes the loan service request, the present invention prompts the user for a variety of information associated with the loan service request. Information associated with the loan service request may include, but is not limited to, contact information (a name, a phone number, an address, a social security number, a username, or the like of a customer), account information (an account number, a routing number, a customer number, a loan number, a loan amount, or the like associated with a customer or a loan), verification information (a password, a passcode, a personal identification number (PIN), or the like associated with a caller, a customer, a loan, or an account), a type of loan service request, notes or comments associated with the loan service request, or the like. In specific embodiments of the invention, the user manually inputs information associated with the loan service request or the customer via an interface. The interface may include multiple pages, tabs, input fields (e.g., text fields, check boxes, selection menus, buttons, or the like) that enable the user to input information associated with the loan service request. In other embodiments the present invention is configured to receive or retrieve a myriad of information and input types associated with the loan service request, thus enabling the user to process many different types of loan service requests.

According to specific embodiments of the invention, as the user is directed through the processing of the loan service request, the present invention unlocks access to certain information fields as the user inputs certain pieces of information. For example, input of information deemed important, such as a customer name, may be required to be inputted by the user before the user may proceed with further processing of the loan service request. In some embodiments, a minimum amount of information is required on particular pages of the interface to be inputted in order for the loan service request to be deemed adequately documented. In other embodiments, the amount of information inputted via the present invention is irrelevant to a complete processing or documentation of the loan service request.

Once the user has completed documenting the loan service request (e.g., when the user has inputted information associated with the loan service request necessary to effectively process the loan service request), embodiments of the present invention are configured to process the inputted information associated with the loan service request so that a formalized script of the inputted information associated with the loan service request is generated. The inputted information associated with the loan service request is transformed into text, numerals, or the like so that the information is properly documented.

In specific embodiments of the invention, the output of the generated script is be standardized across all types of loan service requests, or for a particular type of loan service request. Standardization may ensure that the documentation associated with processing the loan service request is uniform and thus easily displayed and understood throughout the entity. Therefore, if another agent needs to process or understand the loan service request, the agent may read the generated formalized script and know exactly where to look for certain pieces of information. For example, in specific embodiments of the invention, the generated script includes the customer name at the top of the script. In related embodiments of the invention, other pieces of inputted information associated with the loan service request are separated or organized in a particular fashion that makes it efficient to read or process (e.g., different pieces of information may be separated by paragraphs, line breaks, different font styles, or the like).

In accordance with embodiments of the present invention, the generated script is to be presented to the user via a text window or another interface. The present invention may further enable the user to copy the generated script. In some embodiments, the generated script is automatically copied to a clipboard associated with the user's computing device. While in other embodiments of the invention, the user manually copies the generated script to input into another application or program.

While processing or documenting the loan service request, the present invention may not save any of the inputted information associated with the loan service request. Instead, once the loan service request has been adequately processed or documented, the inputted information associated with the loan service request is deleted from any or all records created when processing or documenting the loan service request. Furthermore, according to specific embodiments of the invention, the generated script is not saved and therefore is deleted upon completion of processing or documenting the loan service request.

The present invention may be integrated with one or a plurality of other applications, web browsers, databases, or the like. In some embodiments, the present invention is configured to accept and process online payments, phone payments, credit card payments, or another type of payment. Generating the formalized script of information associated with the loan service request may further ensure compatibility of the information with other applications used to process the loan service request or used to assist the customer in executing his or her desired loan service requests.

In some embodiments, the present invention is configured to accept updates or modifications of functionality when processing the service request. The present invention may enable the user to manually configure the interfaces, the requirements for information, settings, or the like. The present invention may further enable the user to select, modify, sort, add, or delete inputted information or types of inputted information. In other embodiments, the present invention enables the user to schedule a meeting or conference with the customer, another agent involved in processing the loan service request, or the like.

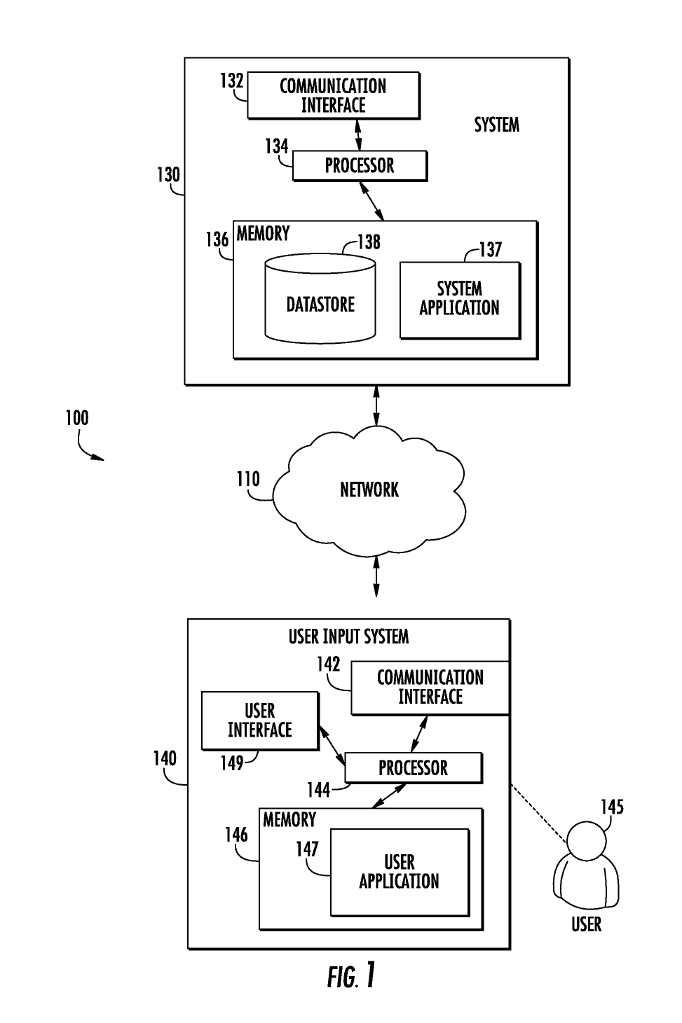

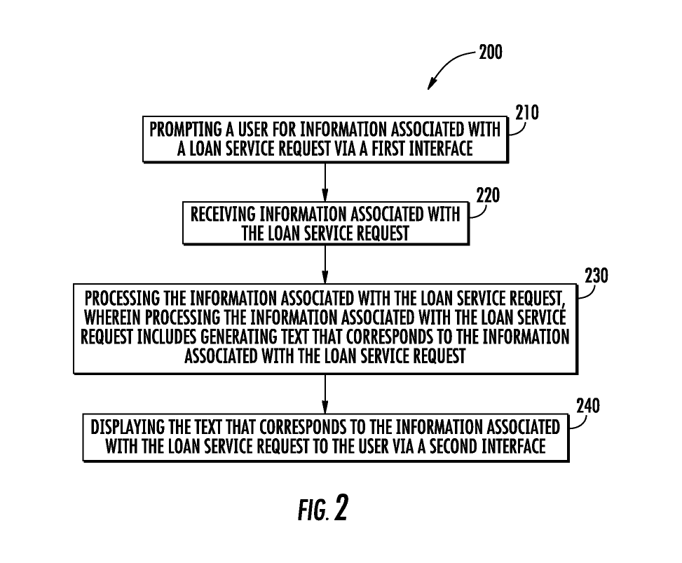

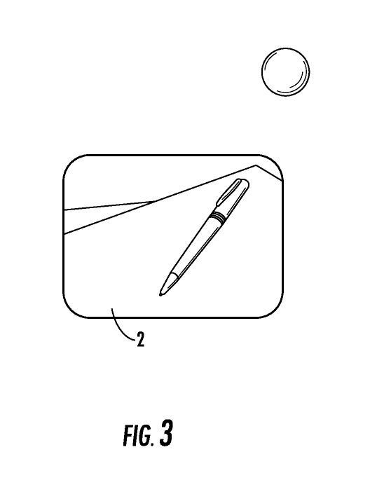

FIG. 1 presents an exemplary block diagram of the system environment 100 for implementing the process flows described in FIG. 2 and the exemplary interfaces in FIGS. 3-10 in accordance with embodiments of the present invention. As illustrated, the system environment 100 includes a network 110, a system 130, and a user input system 140. Also shown in FIG. 1 is a user 145 of the user input system 140. The user input system 140 may be any computing device. The user 145 may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 is secure and may also include wireless and/or wireline and/or optical interconnection technology.

The user input system 140 may include any computerized apparatus that can be configured to perform any one or more of the functions of the user input system 140 described and/or contemplated herein. For example, the user 145 may use the user input system 140 to transmit and/or receive information or commands to and from the system 130. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having a user application 147 stored therein, and a user interface 149. In such embodiments, the communication interface 142 is operatively and selectively connected to the processor 144, which is operatively and selectively connected to the user interface 149 and the memory 146. In some embodiments, the user 145 may use the user application 147 to execute processes described with respect to the process flow and interfaces described herein. Specifically, the user application 147 executes the process flow described in FIG. 2.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user 145. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 145. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the entity. The system 130 may be located at the facility associated with the entity or remotely from the facility associated with the entity. In some embodiments, such as the one illustrated in FIG. 1, the system 130 includes a communication interface 132, a processor 134, and a memory 136, which includes a system application 137 and a datastore 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the datastore 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the datastore 138. As used herein, the datastore 138 may be one or more distinct and/or remote datastores. In some embodiments, the datastore 138 is not located within the system and is instead located remotely from the system. In some embodiments, the datastore 138 stores information or data described herein.

It will be understood that the datastore 138 may include any one or more storage devices, including, but not limited to, datastores, databases, and/or any of the other storage devices typically associated with a computer system. It will also be understood that the datastore 138 may store information in any known way, such as, for example, by using one or more computer codes and/or languages, alphanumeric character strings, data sets, figures, tables, charts, links, documents, and/or the like. Further, in some embodiments, the datastore 138 may include information associated with one or more applications, such as, for example, the system application 137. It will also be understood that, in some embodiments, the datastore 138 provides a substantially real-time representation of the information stored therein, so that, for example, when the processor 134 accesses the datastore 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

FIG. 2 presents a process flow 200 describing an apparatus that enables a user to efficiently document a loan service request. At block 210, the process includes prompting a user for information associated with a loan service request via a first interface. At block 220, the process includes receiving information associated with the loan service request. At block 230, the process includes processing the information associated with the loan service request, wherein processing the information associated with the loan service request includes generating text that corresponds to the information associated with the loan service request. At block 240, the process includes displaying the text that corresponds to the information associated with the loan service request to the user via a second interface.

FIG. 3 illustrates an exemplary user interface for a landing page. The user may select the start tab 2 to begin the documentation process during a loan service request.

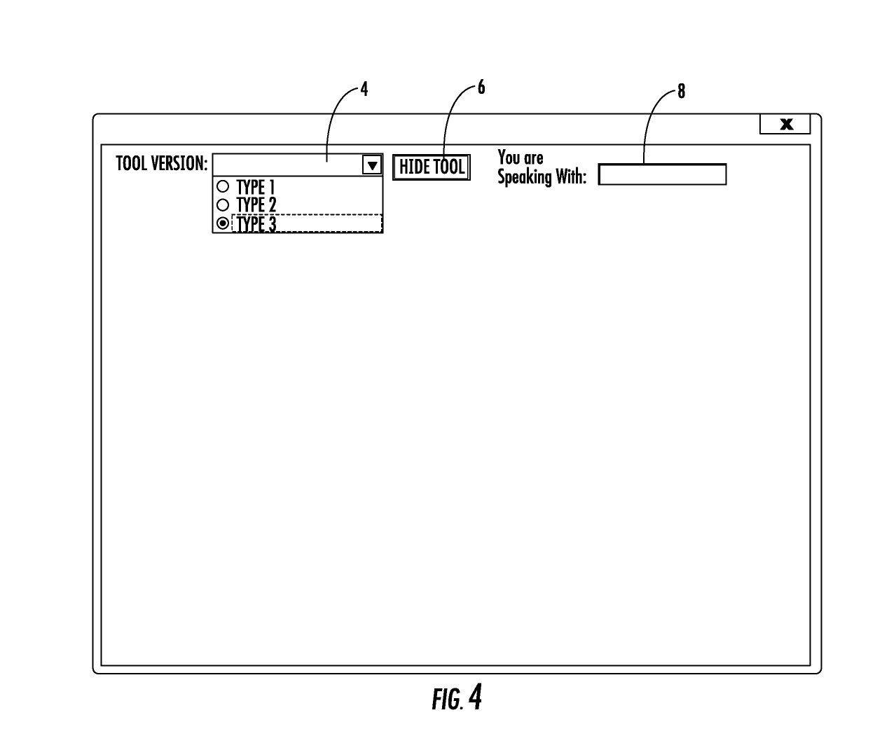

Selecting the start tab 2 presents to the user a menu interface such as the one depicted in FIG. 4. From the menu, the user may select a tool version 4 based on the type of received loan service request, including Collection Types 1-4. A hide tool tab 6 may enable the user to hide, minimize, or exit the documentation interface. A caller name text field 8 may be displayed so that the user may refer to the caller by name throughout the loan service request documentation process.

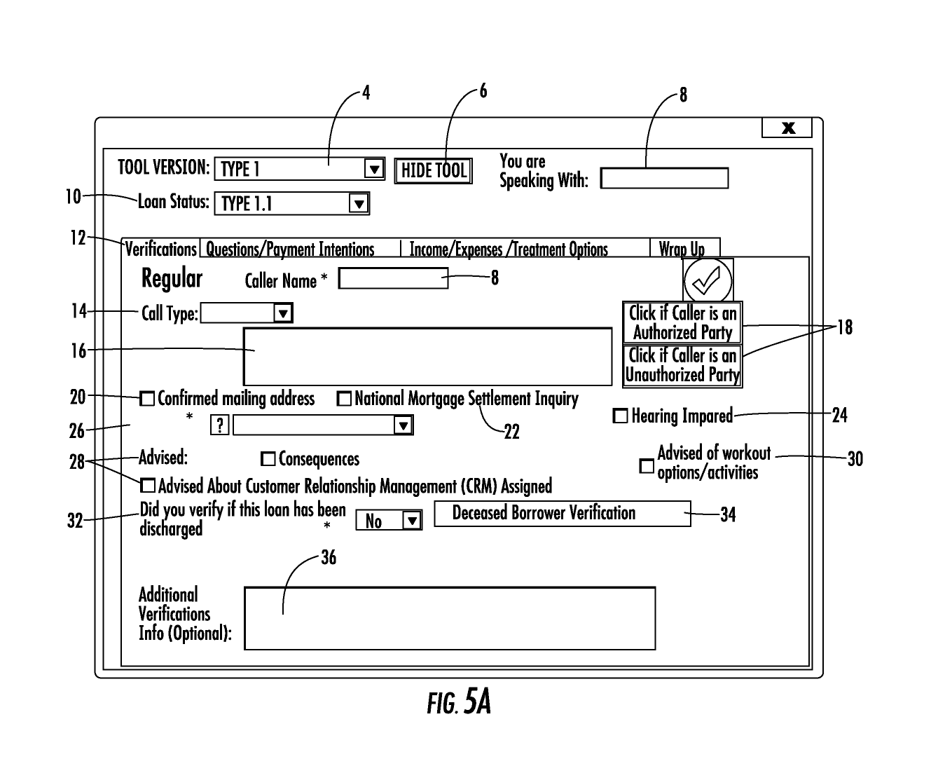

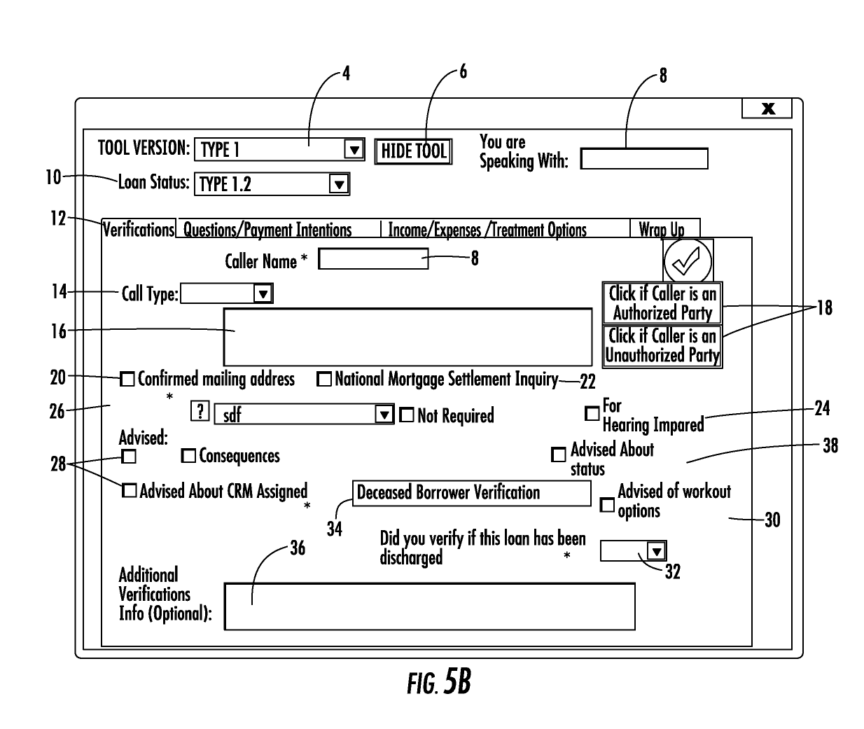

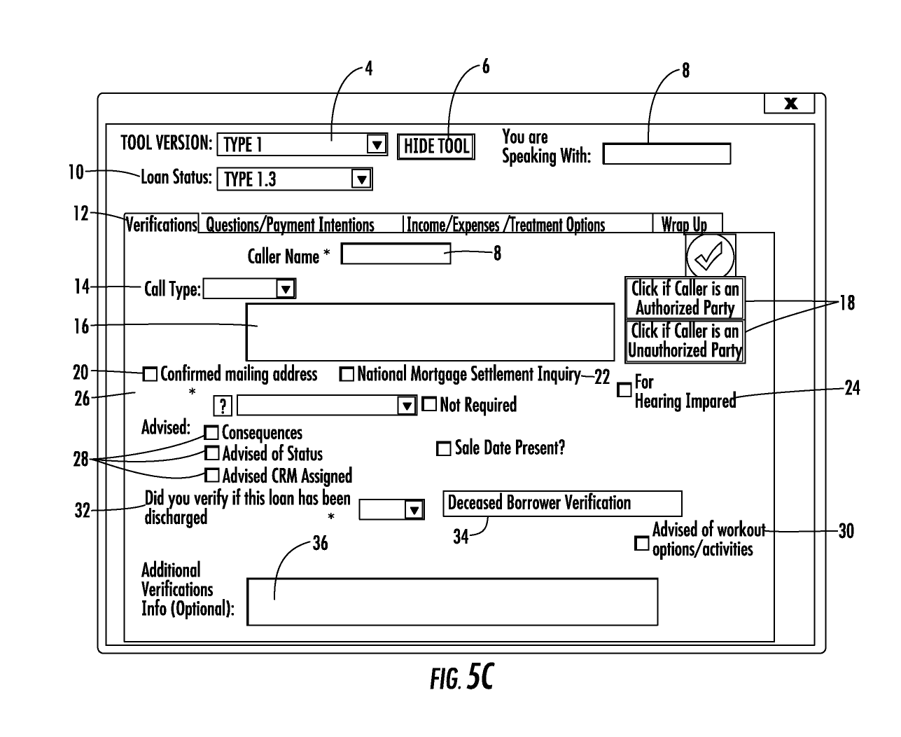

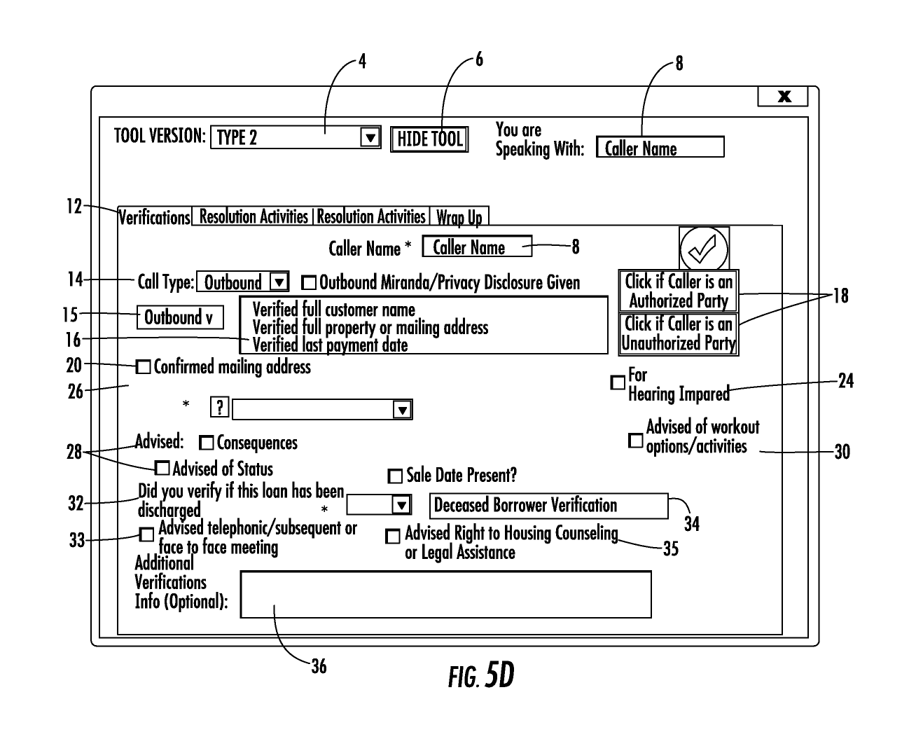

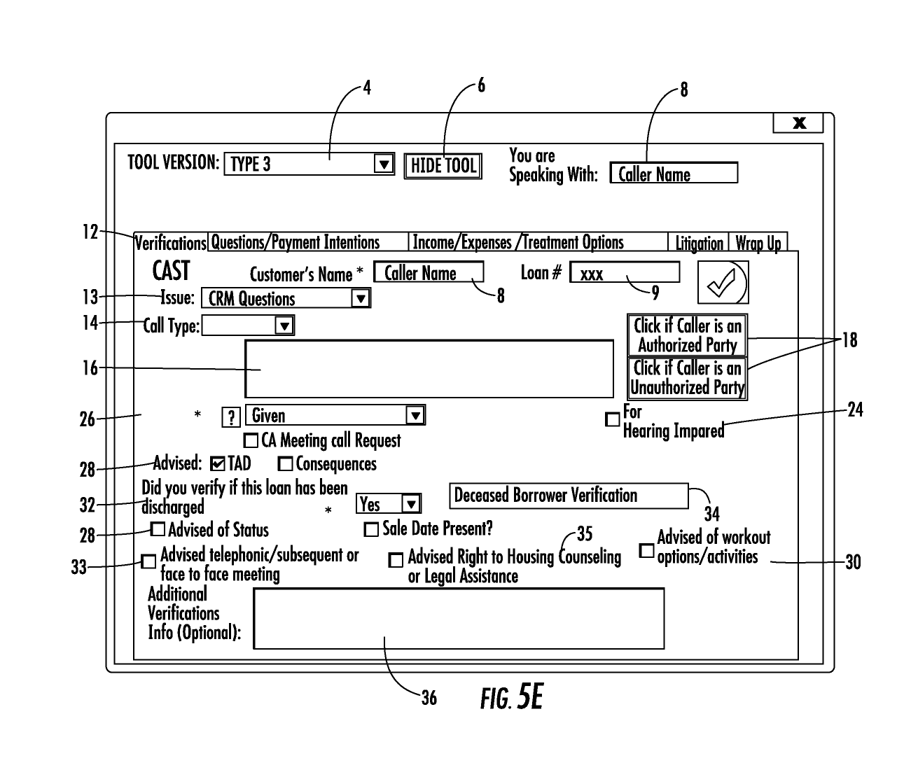

FIG. 5A illustrates an exemplary user interface for verification 12 of the loan service request, an identity of a caller who initiated the loan service request, or the like. The verification 12 page may include a loan status or Collection Subtype (e.g., 1.1, 1.2, or 1.3) 10, a caller name 8, a call type 14, a comments text field 16, and means for authorizing the caller 18 that may enable the user to input more information associated with the caller, the caller's account, or the like. The user may confirm a mailing address 20, inquire about a national mortgage settlement 22, denote if the caller is hearing impaired 24, determine or select a particular state 26, denote if the user advised the caller on various aspects of the loan service request 28, 30, verify if a loan has been discharged 32, or if the caller inquires about a loan associated with a deceased borrower 34. Additional verification information may be entered at the discretion of the user via a text field 36. FIGS. 5B-5E illustrate similar means for enabling the user to document additional pieces of verification information, including advising the caller about a status 38, scheduling a meeting 33, or a right to legal assistance 35. Certain pieces of verification information may require the user to input additional verification information via a pop-up window, a menu selection, a check box, or the like. Some information, perhaps denoted by an asterisk or other symbol, may be required to be documented by the user before the user is able to continue processing and documenting the loan service request.

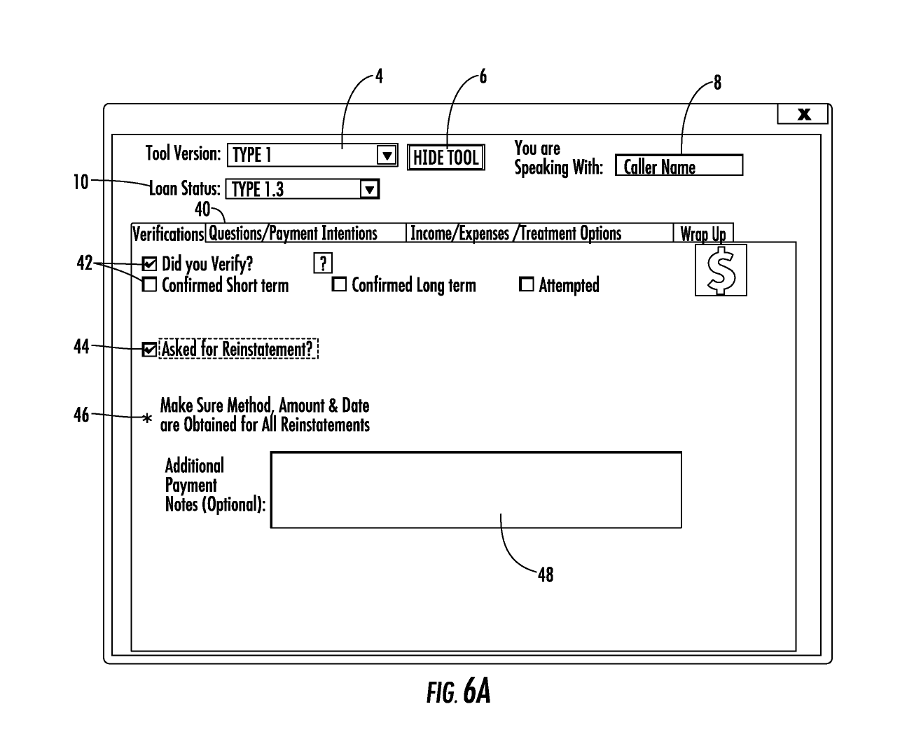

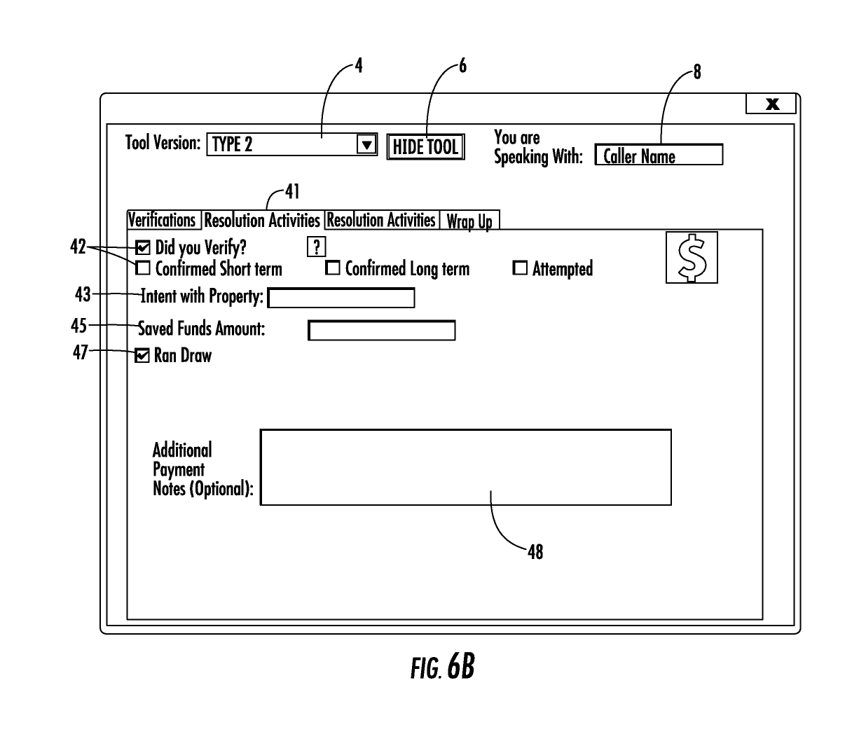

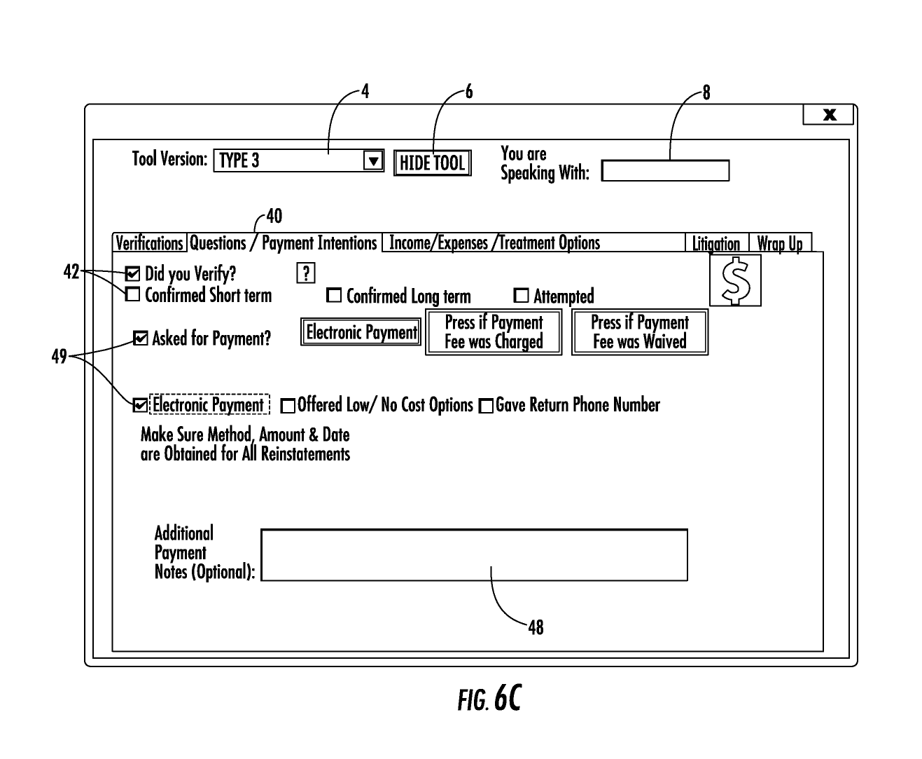

FIG. 6A illustrates an exemplary user interface for a page that enables the user to document information associated with payments 40. The user may document if he verified a variety of information associated with reasons as to not-yet-received payments 42 or if the caller requested reinstatement of a loan status 44. The interface may also provide instructions 46 to the user. Any additional user comments related to payments about the loan service request may be entered into the text field 48. FIG. 6B is directed to an exemplary user interface for inputting information associated with resolution activities. The user may be enabled to verify information similar to that in FIG. 6A. Further, the user may also be enabled to input information associated with an intent associated with a property 43, a saved funds amount 45, or if the user has ran a draw on an account 47. FIG. 6C illustrates another exemplary user interface for payment information 40. Including similar information fields as FIG. 6A, FIG. 6C may also include information associated with collecting a payment 49. The present invention may be configured to collect an electronic payment, or may be integrated with a third party online payment service.

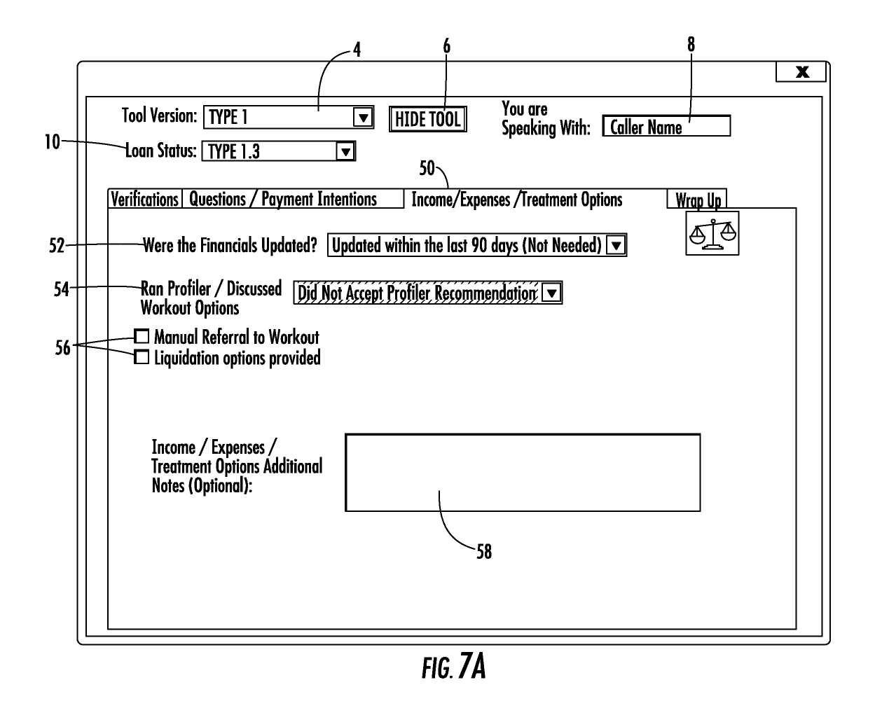

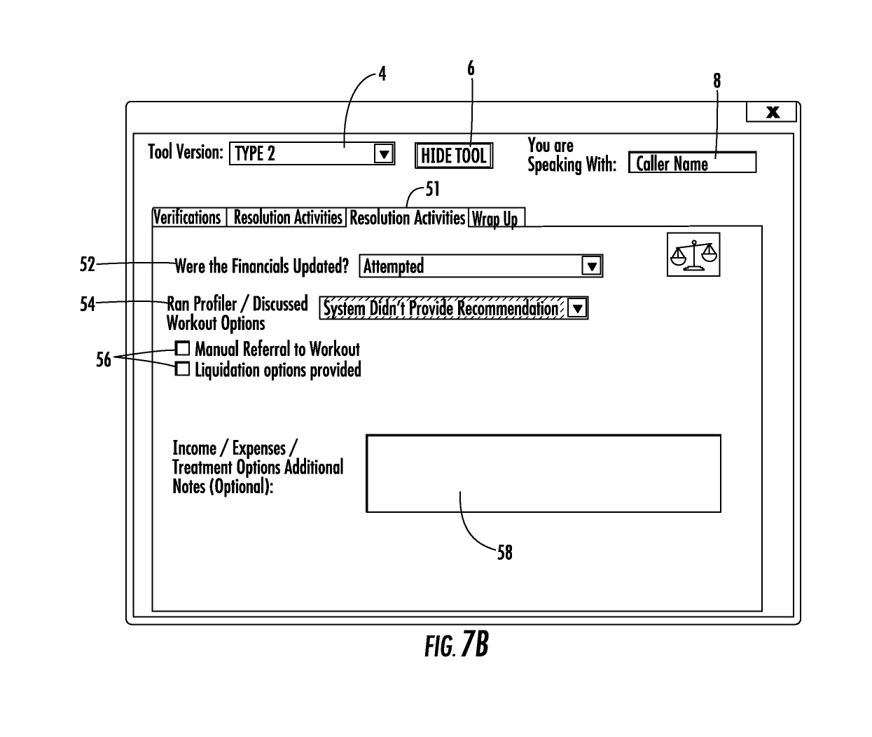

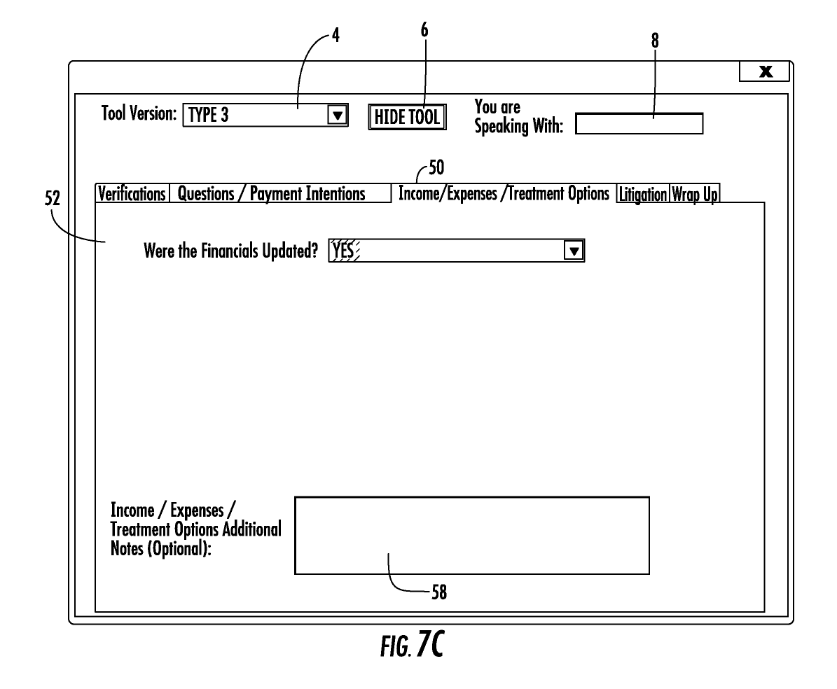

FIG. 7A illustrates an exemplary user interface for a page that enables a user to input or document information associated with income, expenses, and treatment options 50. The user may document if financials were updated 52 via a selection, if a profile was run and if options have been discussed 54, or if a referral was given 56. Additional information may be inputted via a text field box 58. FIG. 7B illustrates a similar exemplary user interface for resolution activities 51. FIG. 7C illustrates yet another similar exemplary user interface for income, expenses, and treatment options 50.

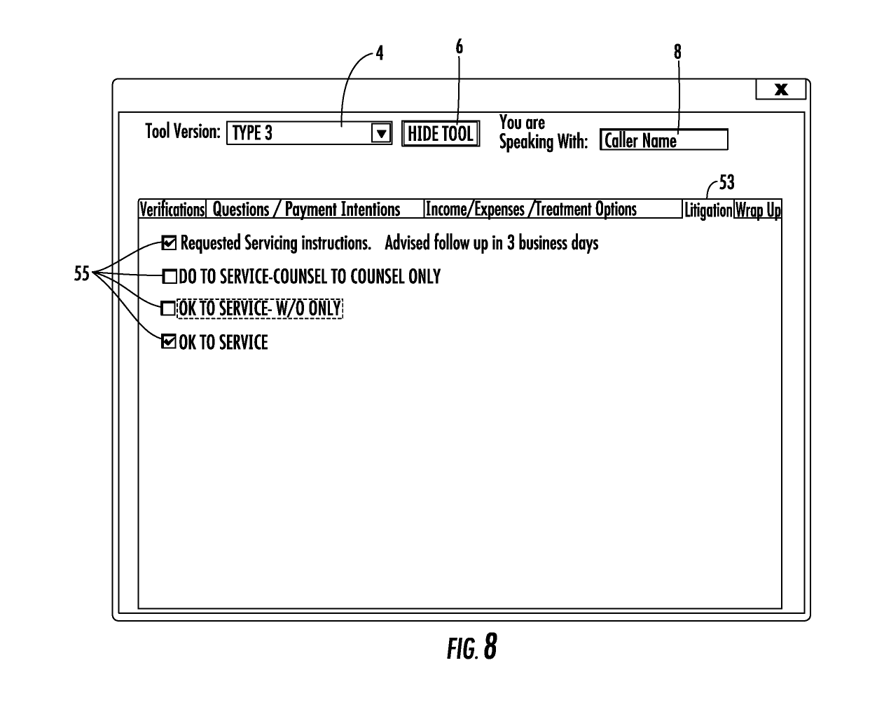

FIG. 8 illustrates an exemplary user interface for inputting information associated with litigation 53. The user may be enabled to select or input information associated with requested litigious services.

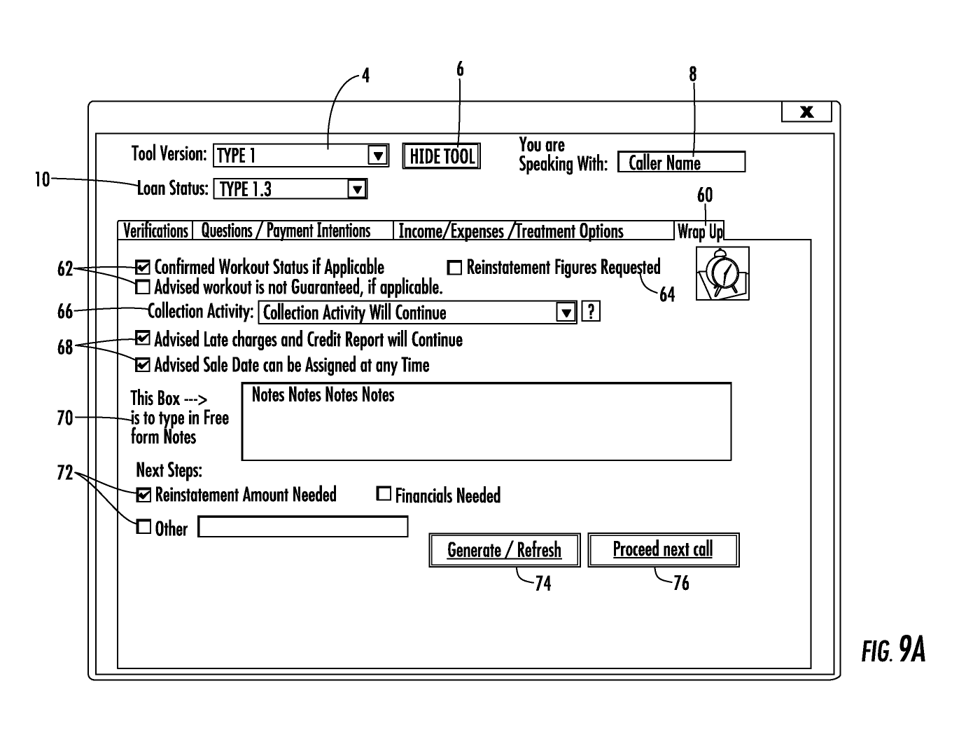

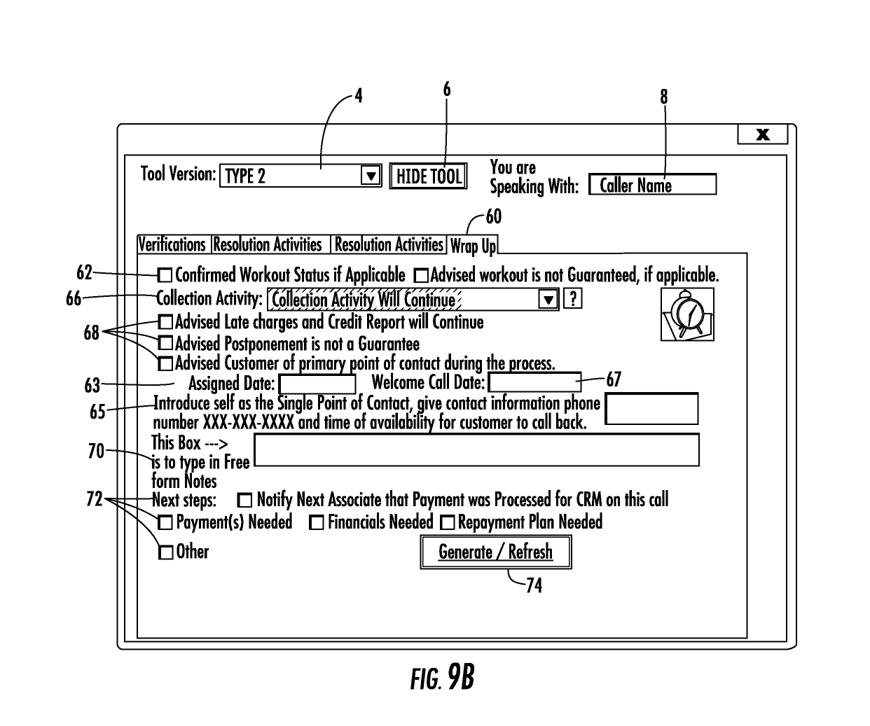

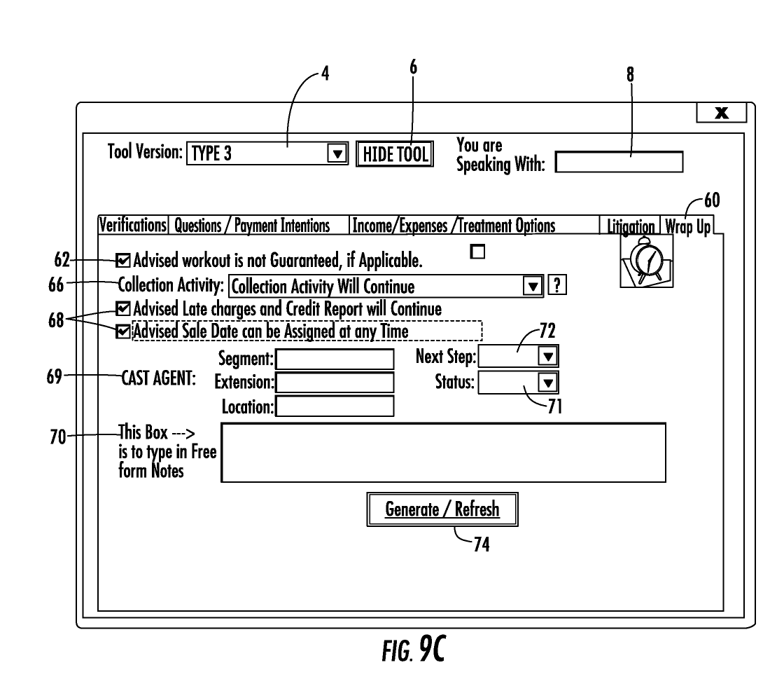

FIG. 9A illustrates an exemplary user interface for reviewing information via a wrap up page 60. The user may confirm a status associated with a workout 62, document if loan reinstatement figures have been requested 64, select a collection activity 66, document if the user has advised the caller 68, or input comments via a text field 70. Next steps 72 may also be documented. FIGS. 9B and 9C introduce similar interfaces and may include additional information. For example, FIG. 9B may enable the user to denote an assigned date 63, a call dated 67, or a contact phone number 65. FIG. 9C may enable the user to denote information associated with an agent 69 or a status 71.

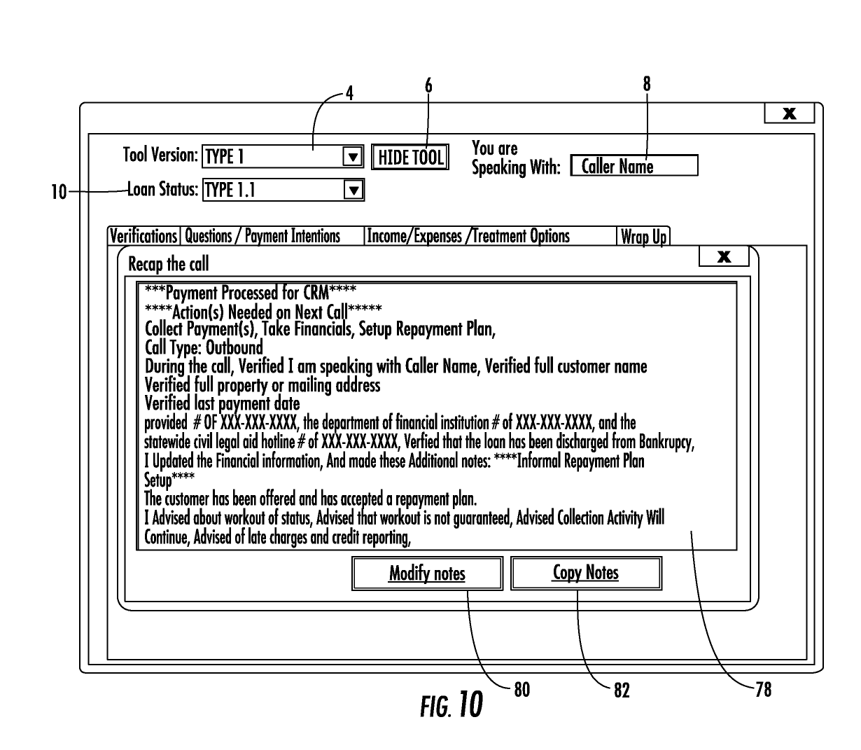

Once the user has completed documenting the loan service request, the user may select a generate/refresh 74 tab. Selecting this tab may cause the present invention to compile the inputted information and transform the inputted information into an organized or standardized string of text 78 and numerals. The text 78 may be presented to the user as shown in FIG. 10. The text 78 may be modified 80 or copied 82. Lastly, the user may clear all field entries and proceed to the next service request call 76.

Clearly, the present invention provides the user with many benefits. The present invention helps in minimizing user mistakes in documentation for loan service requests, thus resulting in a process with higher quality assurance (QA) than prior documentation approaches. Moreover, the present invention provides a standard of displaying and communicating information associated with the loan service requests, and therefore makes communication easier between both internal and external users. Furthermore, the present invention reduces the amount of time it takes to document loan service requests, which indubitably saves the entity money.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for documenting a loan service request, the apparatus comprising:
a memory;
a processor; and
a module stored in memory, executable by a processor, and configured to:
prompt a user for information associated with the loan service request via a first interface;
receive information associated with the loan service request;
process the information associated with the loan service request, wherein processing the information associated with the loan service request includes generating text that corresponds to the information associated with the loan service request; and
display the text that corresponds to the information associated with the loan service request to the user via a second interface.

2. The apparatus of claim 1, wherein the first interface includes at least one of a check box, a text input field, a selection menu, and a button.

3. The apparatus of claim 2, wherein the first interface enables the user to manually input information associated with the loan service request.

4. The apparatus of claim 1, wherein receiving information associated with the loan service request includes retrieving information associated with the loan service request from a second apparatus.

5. The apparatus of claim 1, wherein receiving information associated with the loan service request further includes prefilling the first interface with information associated with the loan service request.

6. The apparatus of claim 1, wherein the information associated with the loan service request includes at least one of contact information, account information, or identity verification information associated with a customer.

7. The apparatus of claim 6, wherein contact information includes at least one of a customer name, a phone number, a physical address, an email address, a social security number, and a customer number.

8. The apparatus of claim 6, wherein account information includes at least one of an account number, a customer number, a loan number, a service request number, a service request history, a purchase history, an account balance, an invoice amount, a credit balance, an account type, an account status, and a routing number.

9. The apparatus of claim 6, wherein identity verification information includes at least one of a username, a password, a personal identification number (PIN), a security question, an answer to a security question, a number of identity verification attempts, a status, location information, and a biometric.

10. The apparatus of claim 1, wherein processing the information associated with the loan service request does not include storing the information associated with the loan service request.

11. The apparatus of claim 10, wherein processing the information associated with the loan service request includes deleting the information associated with the loan service request.

12. The apparatus of claim 1, wherein processing the information associated with the loan service request includes translating at least one of a checked box, an inputted text string, an inputted numerical string, and a selection into a text string.

13. The apparatus of claim 1, wherein generating text that corresponds to the information associated with the loan service request includes generating the text according to a predetermined template.

14. The apparatus of claim 1, wherein displaying the text that corresponds to the information associated with the loan service request includes copying the text to a virtual clipboard.

15. The apparatus of claim 1, wherein displaying the text that corresponds to the information associated with the loan service request includes transmitting the text to a second apparatus for documentation purposes.

16. The apparatus of claim 1, wherein processing the information associated with the loan service request includes receiving an electronic payment.

17. The apparatus of claim 1, wherein processing the information associated with the loan service request includes authenticating a customer associated with the loan service request.

18. The apparatus of claim 1, wherein prompting the user for information associated with the loan service request includes providing instructions to the user for at least one of inputting, receiving, and processing information associated with the loan service request.

19. A method for documenting a loan service request, the method comprising:
prompting a user for information associated with the loan service request via a first interface;
receiving information associated with the loan service request;
processing the information associated with the loan service request, wherein processing the information associated with the loan service request includes generating text that corresponds to the information associated with the loan service request; and
displaying the text that corresponds to the information associated with the loan service request to the user via a second interface.

20. A computer program product for documenting a loan service request, the computer program product comprising:
a memory;
a processor; and
a module stored in memory, executable by a processor, and configured to:
prompt a user for information associated with the loan service request via a first interface;
receive information associated with the loan service request;
process the information associated with the loan service request, wherein processing the information associated with the loan service request includes generating text that corresponds to the information associated with the loan service request; and
display the text that corresponds to the information associated with the loan service request to the user via a second interface.
